(19) United States
(12) Patent Application Publication
(10) Pub. No.: US 2024/0075403 A1
(43) Pub. Date: Mar. 7, 2024

(54) THIN FILM EVAPORATOR, AND METHOD FOR PRODUCING A TRANSFER MIXTURE

(71) Applicant: List Technology AG, Arisdorf (CH)

(72) Inventors: Manuel Steiner, Basel (CH); Roland Kunkel, Frankfurt a.M. (DE); Daniel Witte, Grenzach-Wyhlen (DE); Judith Andrea Michelle Günther, Lörrach (DE)

(73) Assignee: List Technology AG, Arisdorf (CH)

(21) Appl. No.: 18/272,193

(22) PCT Filed: Jan. 12, 2022
(86) PCT No.: PCT/EP2022/050473

§ 371 Date: Jul. 13, 2023

(30) Foreign Application Priority Data
Jan. 13, 2021 (DE) 10 2021 100 475.6

(51) Int. Cl. B01D 1/22; C08B 1/00; D01D 1/02; D21C 9/18

(52) U.S. Cl. CPC B01D 1/225; C08B 1/003; D01D 1/02; D21C 9/18; D10B 2201/22

(57) ABSTRACT

The invention relates to a thin film evaporator (D) for producing a transfer mixture according to the direct dissolution method, having a feed (1), a housing (4) and an outlet (2), wherein the feed (1) introduces a starting material, made of cellulose, water and a functional fluid, into the housing (4), wherein an evaporator shaft (5) situated in the housing (4) rotatingly sweeps the starting material over the heated interior of the housing (4), wherein the product is heated and some of the water evaporates so as to result in the transfer mixture, which flows to the outlet (2) together with a supply stream, wherein the through-flow capacity of the outlet (2) is greater than the supply stream.

### BACKGROUND OF THE INVENTION

The invention relates to a thin film evaporator for producing a transfer mixture and to a method for producing a transfer mixture.

Such thin-film evaporators are already known and in use in a variety of forms and designs. For example, WO 96/33302A discloses a system for producing cellulosic films, fibers and other molded articles by the amine oxide process. Here, two mixing devices with two different pulpers are preferably used. With the aid of these mixing devices, the cellulose pulp is first to be defibered or ground, wherein a pump pumps a first suspension of cellulose pulp in an aqueous amine oxide solution with a dry pulp density of no more than 10% by mass of dry cellulose pulp into a device wherein the apparatus reduces the amount of water present until the suspension is converted to a concentrated pulp suspension, wherein from the apparatus the concentrated pulp suspension is transferred to a further apparatus, wherein the concentrated pulp suspension produced is converted to a formable solution of cellulose.

Thereby, a discharge pump is provided between the device and the further device. Both devices can be designed as thin film evaporators. However, a buildup of the concentrated pulp suspension in the form of a liquid accumulation is required between the device and the further device, so that the discharge pump can operate.

For this purpose, the device has a truncated extension at the lower end of the container, which opens into a corresponding receiving space into which the concentrated pulp suspension is admitted. It is additionally taught that for stirring the concentrated pulp suspension, an agitator with a rotor can be provided and radioactive level measurement is possible in this receiving space. This receiving space also has an opening which is provided for evacuating the container and for drawing off water vapor. The disadvantage of this is that in the receiving space material accumulation can occur in the discharge area, which can lead to decomposition of the amine oxide, which in turn can increase the risk of explosion. This is possible if more water evaporates out of schedule, so that the suspension concentrates This is possible if more water evaporates out of schedule, so that the suspension concentrates to such an extent that the high heating temperatures common in thin-film reactors trigger an explosive decomposition of the amine oxide.

It is also disclosed that the further device performs water evaporation under vacuum.

Furthermore, WO 2008/086550 A1 discloses a thin film evaporator in which the starting mixture is pumped into the thin film evaporator by a pressure-building pump and is pumped out again as a solution at the end of the process by a further pump, which, because of the vacuum operation, can only be carried out with a pressure-building or pressure-blocking discharge element, such as typically a gear pump, connected directly or—via a discharge element such as typically a screw indirectly.

Also disclosed in the WO 2008/154668 A1 is a thin film evaporator for the production of a lyocell spinning solution, wherein the conveying elements on the shaft of the thin film evaporator are steeply angled for rapid product transport to reduce the risk of overheating and consequently an exothermic reaction even at high heating temperatures, and the thin film evaporator merges into a screw at the end, which feeds a pump that pumps the spinning solution through pipes to spinnerets. This solution can only be implemented if the spinning solution is dammed up in front of the pump, because otherwise the operation of the pressure-building pump and operation of the thin film evaporator at vacuum is not possible. Although the steeply angled conveying elements thus reduce the risk of explosion, the disadvantage of this method remains that the spinning solution to be accumulated in front of the pump still represents an explosion risk in the event of unscheduled overheating.

The DE 10 2012 103 749 A1 shows a thin film evaporator which discloses a rotor in the outlet area of the thin film evaporator for mixing and discharging the product. The described operation mode, which extends the residence time, leads to an accumulation of product in the conical outlet area, which partially accumulates up to the height of the cylindrical device part. Despite the disclosed product-discharging properties of the thin film evaporator, product accumulation thus occurs. The residence time required to produce spinning solutions is usually generated in thin film evaporators by the method described above. Due to the accumulation of product, there is an increased risk of explosion caused by possible product overheating.

While thin film evaporators are mostly designed with a vertical orientation of the evaporator shaft as described for example the WO 1994/006530 A1, they can also be designed with a horizontal orientation of the evaporator shaft as described for example in the WO 2020249705 A1.

The skilled person is also aware of the limited size of large industrial thin film evaporators, whose maximum heating jacket area is typically about 50 m². To avoid overheating of the amine oxide, the temperature of the heating jacket is greatly reduced on the discharge side of the thin film evaporator, because the product is already strongly heated there by friction due to increased viscosity. The purpose of reducing the heating jacket temperature is to compensate this mechanical energy input. Consequently, heat is dissipated on the output side to prevent overheating of the spinning solution. On the one hand, this has the disadvantage that not all of the heating jacket surface, which as mentioned above is only available to a limited extent, can be used for thermal energy input. A further disadvantage is the resulting increase in energy costs, firstly because instead of the typically inexpensive thermal energy input via the heating jacket surface, a typically expensive electromechanical energy input takes place via energy dissipation of the rotating evaporator shaft of the thin film reactor, and secondly because cooling involves a heat loss.

### SUMMARY OF THE INVENTION

The object of the present invention is to overcome the disadvantages of the prior art. In particular, a thin film evaporator and a method for evaporating water from a cellulose-water functional liquid mixture shall be described, which can evaporate more water with thermal energy and, in the case of the amine oxide process, can be operated more safely. Herein, the thin film reactor is to produce a transfer mixture and not a spinning solution. This has the advantage that the product in the thin film reactor always has a sufficiently high water content, thus preventing overheating and a resulting potential explosion risk. Furthermore, the device is designed to prevent build-up of the product within the thin film reactor, so that no excessive energy input can result from energy dissipation in the built-up product. In this way, the need to reduce the temperature of the heating jacket is eliminated, so that the entire heating jacket area is available for lower-cost thermal energy input and the electromechanical energy input associated with higher costs can be minimized. Another advantage is that this results in a lower mechanical load on the agitator shaft, so that it can be implemented more cost-effectively. This increases the maximum water evaporation amount per heating jacket area of thin film evaporators at lower energy costs and favorable construction, compared to the use of the thin film evaporator for the production of spinning solution.

This task is not limited to the production of a spinning solution with amine oxide as the functional liquid, where overheating increases the risk of explosion, but also to the production of spinning solutions with ionic liquids as the functional liquid, where overheating does not mean a risk of explosion but can lead to a reduction in quality due to overdrying.

Since the transfer mixture is not yet a spinning solution but a mixture of partially dissolved and undissolved cellulose, water and functional solution, it may still be sensitive to compression, wherein pressure leads to dewatering of the mixture and/or to cellulose agglomerates, which can no longer be dissolved.

It is an object of the present invention to provide a thin film evaporator, which takes into account all the facts mentioned in the definition of the object.

The features disclosed herein lead to the solution of the object.

Advantageous embodiments are also described herein and in the dependent claims.

A thin film evaporator according to the invention is used for producing a transfer mixture by the direct dissolution method.

Thereby, the thin film evaporator has a feed, a housing and an outlet. The feed introduces a starting material consisting of cellulose, water and a functional liquid into the housing. Thereby, a rotating evaporator shaft is arranged in the housing. The starting material is swept over the heated interior of the housing by the evaporator shaft. This causes the starting material to heat up and part of the water evaporates to form the transfer mixture, which flows to the outlet with a supply stream. The outlet is therefore designed in such a way that the feed flow of the transfer mixture passes through the outlet without delay. In this context, the outlet can be an opening whose through-flow capacity is determined and/or limited by its dimensions. The opening width can also be variable, i.e. openable or closable.

Thereby, the through-flow capacity of the outlet is greater than the supply stream. Through-flow capacity is thereby defined as the flow rate at full feed. In addition, the full feed is defined as the flow rate at full capacity at the current setting parameters of the outlet or a transfer device and not at its maximizing setting parameters.

The term through-flow capacity thus has the objective of a functional description of what, for example, a transfer organ would convey more with existing setting parameters if it were fed with a maximum of more material. Thereby the effective mode of operation is described, e.g. the maximum flow at effectively set speed of a pump, and not the maximum flow at maximum adjustable speed of the addressed pump.

Similarly, a through-flow capacity that is greater than the supply stream, i.e. in the case of a simple opening, describes that all material flowing in falls out gravimetrically immediately through a sufficiently large opening.

An advantage of the thin film evaporator according to the invention is that, due to the composition from the starting material to the transfer mixture, no possibly dangerous or product-damaging temperatures can be reached.

Also, neither the starting material, nor the transfer mixture are brought into a state of complete solution. This is the case when all the essential cellulosic solid components of the starting material have been dissolved completely in the functional liquid and consequently a homogeneous moldable mass is present.

This state prior to the occurrence of the state of complete solution is defined as the state of the transfer mixture. In contrast to the suspension, the cellulose is partially dissolved in the transfer mixture.

The starting material thereby becomes a transfer mixture from the feed to the outlet.

The outlet opens into a subsequent processing organ, which is preferably better suited than the thin film evaporator for the safe transfer of the transfer mixture into a spinning solution. Here, such a processing unit can be a mixing kneader, as described in WO 2013/156489A1, which, thanks to good high-viscosity mixing properties and effective mechanical energy input via the shaft, the speed of which can be quickly set and also quickly reduced to zero again, can regulate the temperature with great accuracy and reliably and, as a rule, avoids cooling or heat dissipation. Thus, the increased energy efficiency and process reliability applies not only to the method step of producing the transfer mixture but also, in combination with a suitable subsequent processing organ, to the entire transfer of a starting material into a spinning solution.

A further thin film evaporator can also be considered as a processing organ—accepting the above-mentioned disadvantages—wherein the overall design of the thin film evaporator can be adapted to achieve the transfer mixture and the further thin film evaporator can be adapted to the processing of the transfer mixture by its further overall design, such as overall length, angle of its wiper blades or the like. The subsequent processing organ is thereby defined in such a way that the processing organ can further process the transfer mixture into a molding solution. The molding solution can then be used, for example, for spinning.

In addition, it may be provided, that the processing chamber of the subsequent processing organ and the process space of the housing form a common gas space. In this context, a common gas space means that the housing and the subsequent processing unit are in pressure equilibrium with each other, so that the same pressure ratios of a vacuum result for a typical pressure range of 10-100 mbara, preferably 20-75 mbara in the gas space. Equal pressure ratios thereby also include pressure gradients across the gas space within the pressure range.

It is further possible that the outlet opens into a subsequent transfer organ, wherein the through-flow capacity of the transfer element is greater than the supply stream. The transfer organ may be a pipe, conduit, screw or pump. It requires the provision of a correspondingly large through-flow capacity. In the case of a pipe, for example, this can be the provision of an appropriately large cross-section and/or a gradient. Ultimately, it does not matter how the skilled person achieves the required through-flow capacity. In the case of a screw or pump, the through-flow capacity must also be designed to be appropriately large. In the case of a screw, for example, this can be achieved by a corresponding number of revolutions.

Thereby, the transfer organ is usually arranged between the thin film evaporator and the subsequent processing organ. It is therefore not used for transferring a molding solution for spinning, but for transferring the transfer mixture from the thin film evaporator to the subsequent processing organ, which converts the transfer mixture into a spinnable solution. The advantage here is that the design of the transfer organ enables a continuous process.

The subsequent processing organ and the housing and the transfer organ can form a further common gas space. An exchange of the transfer mixture from the housing to the subsequent processing organ, for example, is therefore not effected by different pressure ratios, but by gravity or mechanically by a screw or pump, for example.

With a certain composition, a solution is formed from the functional liquid water and cellulose. N-Methylmorpholine-N-Oxide (NMMO) or an ionic liquid can be considered as the functional liquid. Thereby, it depends on the selection of the functional liquid at which parameters, such as cellulose content and water content, a solution is formed that can be considered, for example, as a Lyocell spinning solution.

The transfer mixture has the advantage that the product in the thin film evaporator always has a sufficiently high water content, thus preventing significant overheating and, in the case of NMMO as the functional liquid, a resulting potential explosion risk, and thus the heating temperature towards the discharge side of the thin film evaporator does not have to be lowered or not lowered significantly, but that there is always a temperature difference necessary for a thermal energy input, i.e. the difference between heating temperature and product temperature, of at least 20° C., preferably 50° C. and ideally 70° C., when avoiding a substantial overheating the product temperature corresponds to the equilibrium temperature. Another advantage is that this results in lower mechanical stress on the evaporator shaft of the thin film evaporator due to lower viscosity, so that the thin film evaporator can be produced more cost-effectively. This increases the maximum amount of water evaporated per heating surface of thin film evaporators while at the same time reducing energy costs and making the construction more favorable. The more favorable design results, for example, from the fact that conventional thin film evaporators can be made larger and thus more material can be processed than it was previously possible. Thus, both the higher water evaporation volume per heating surface and the larger design increase the production capacity per production line.

If the functional fluid in the starting material is NMMO, the material properties of the transfer mixture with the general composition of

maximum X_{H2O}=−0.235X_{Cell}+0.235

minimum X_{H2O}=−0.59X_{Cell}+0.2047

is achieved.

Even more preferably, the transfer mixture is applied to the preferred composition of

maximum X_{H2O}=0.2864X²_{Cell}−0.6786X_{Cell}+0.2288

minimum X_{H2O}=0.2864X²_{Cell}−0.6786X_{Cell}+0.2188.

In the general composition, discharge of the transfer mixture is already advantageous because sufficient water has evaporated so that a transfer mixture is formed and a further processing to solution in the subsequent processing organ can be carried out in a relatively short process time. In the preferred composition of the transfer mixture, the maximum amount of water is already closer to the complete solution. On the other hand, the minimum amount of water has a greater distance to this complete solution. In this way, further processing can be realized in a short process time and, at the same time, the risk of overdrying of the material in the thin film evaporator can be further reduced. In both cases, however, the transfer mixture is removed from the more complex processing associated with the solution, so that the thin film evaporator according to the invention can operate with the preferred operating characteristics described above.

A method for producing a transfer mixture is disclosed in parallel. The method for producing thereby proceeds by the direct dissolution method in a thin film evaporator having a feed, a housing and an outlet, wherein the feed introduces a starting material of cellulose, water and a functional liquid into the housing, wherein an evaporator shaft arranged in the housing rotationally sweeps the starting material across the interior of the housing and the starting material heats and a portion of the water evaporates to form the transfer mixture, wherein the transfer mixture flows to the outlet with a supply stream, wherein according to the invention the through-flow capacity of the outlet is greater than the supply stream. The definition of through-flow capacity shown above also applies here.

The supply stream is thereby a definable quantity of the transfer mixture per one unit of time, which can be calculated when a quantity per unit of time of starting material enters the housing through the feed and the evaporator shaft heats the starting material and evaporates water. Taking into account the heat energy input over the period of processing by the evaporator shaft, i.e. minus the amount of water evaporated, the supply stream could be calculated and the outlet could be designed with a certain through-flow capacity from the beginning or an adjustable through-flow capacity could be specified by an outlet that could be enlarged, for example, so that a delay-free discharge of the transfer mixture from the housing or the outlet would be possible and thus a continuous process would be given.

In the method, for example, the transfer mixture may be transferred to a subsequent processing organ. The subsequent processing organ can be one of the processing organs already described, such as the mixing kneader or the further thin film evaporator. The subsequent processing organ is thereby to further process the transfer mixture into a molding solution.

As the functional liquid for the starting material, N-Methylmorpholine-N-Oxide (NMMO) or an ionic liquid can be added as the functional liquid. They are used to dissolve the cellulose under appropriate conditions.

Further, in another embodiment, the transfer mixture may pass a subsequent transfer organ, wherein the through-flow capacity of the transfer organ is greater than the supply stream. The transfer organ may be, for example, a pipe, a conduit, a screw or a pump. It requires the provision of a correspondingly large through-flow capacity. This can be done in the case of a pipe or, for example, a conduit, by providing an appropriately large cross-section and/or slope. Ultimately, it does not matter how the skilled person achieves the required through-flow capacity. In the case of a screw or pump, the through-flow capacity must also be designed to be appropriately large. In the case of a screw, for example, this can be achieved by a corresponding number of revolutions.

The transfer organ is thereby arranged, for example, between the thin film evaporator and the subsequent processing organ. It is therefore not used to transfer a solution for spinning, but to transfer the transfer mixture from the thin film evaporator to the subsequent processing organ, wherein the transfer mixture first becomes a spinnable solution in the processing organ. The advantage here is that the design of the transfer organ enables a continuous process.

If the functional fluid added to the starting material is NMMO, the general material properties of the transfer mixture at the general composition of

maximum X_{H2O}=−0.235X_{Cell}+0.235

minimum X_{H2O}=−0.59X_{Cell}+0.2047

is achieved.

Even more preferably, the transfer mixture is applied at the preferred composition of

maximum X_{H2O}=0.2864X²_{Cell}−0.6786X_{Cell}+0.2288

minimum X_{H2O}=0.2864X²_{Cell}−0.6786X_{Cell}+0.2188.

In the general composition and also in the preferred composition, the transfer mixture is in a pre-solution state. Thus, it has also been achieved that the method for the production of lyocell has taken place under optimum operating parameters of the thin film evaporator and that the comparatively difficult material states of the lyocell are avoided if, for example, encrustations occur in the thin film evaporator or overdrying or decomposition takes place. These problematic material states can be relatively easily prevented in the subsequent processing organ, because the subsequent processing organ is generally designed for lower rotational speeds and higher torques, for example.

### BRIEF DESCRIPTION OF THE DRAWINGS

Further advantages, features and details of the invention result from the following description of preferred embodiments and from the drawing; these show in

FIG. 1 a schematic view of a thin film evaporator (D) according to the invention;

FIG. 2 a schematic diagram of the general and preferred material properties of a transfer mixture.

### DETAILED DESCRIPTION

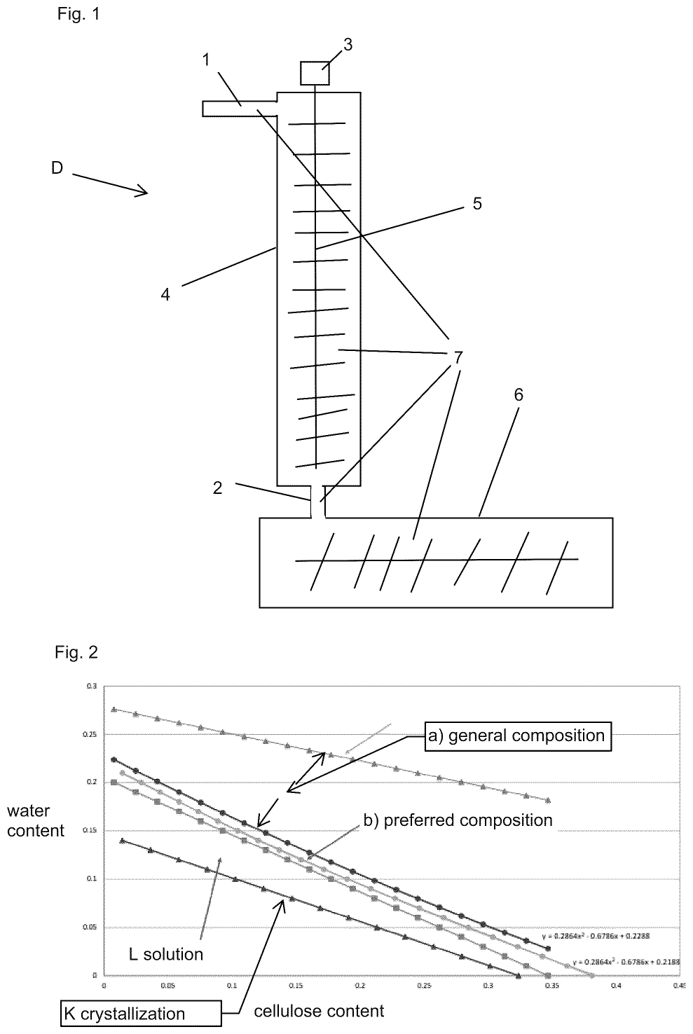

FIG. 1 shows a thin film evaporator D according to the invention, which has a feed 1 that in turn opens into a housing 4. Through the feed 1, a starting material consisting of cellulose, water and a functional liquid enters the housing 4.

The housing 4 has an evaporator shaft 5 inside. The evaporator shaft 5 is rotated by a drive 3. The rotating evaporator shaft 5 sweeps the starting material over the heated interior of the housing 4, wherein the starting material heats up and some of the water evaporates, forming a transfer mixture that flows to the outlet 2 with a supply stream.

It is thereby irrelevant whether the evaporator shaft 5 transports the starting material or, at a later stage of the process, the transfer mixture from the feed 1 to the outlet 2 through its wipers attached to the evaporator shaft and/or whether this process is gravimetric.

The through-flow capacity of the outlet 2 is designed to be greater here than the supply stream.

Here, the outlet 2 opens into a subsequent processing organ 6. Thereby the outlet 2 is oriented at one end in the direction of the housing 4 and at the other end in the direction of the subsequent processing unit 6.

It is also shown that the housing 4 with the feed 1 and the outlet 2, as well as the subsequent processing organ 6 form a common gas space 7, so that a delay-free transfer of the transfer mixture into the subsequent processing organ 6 is made possible.

FIG. 2 shows a diagram illustrating the general and the preferred material composition of the transfer mixture. Thereby, the general composition a has the following parameters of

maximum X_{H2O}=−0.235X_{Cell}+0.235

minimum X_{H2O}=−0.59X_{Cell}+0.2047

and thus shows a larger margin than the preferred composition b, which has the following parameters of

maximum X_{H2O}=0.2864X²_{Cell}−0.6786X_{Cell}+0.2288

minimum X_{H2O}=0.2864X²_{Cell}−0.6786X_{Cell}+0.2188.

As the water content decreases, the area of solution L is reached first, and as the water content decreases further, crystallization K is reached.

Reference List

| | |
|---|---|
| 1 | Feed |
| 2 | Outlet |
| 3 | Drive |
| 4 | Housing |
| 5 | Evaporator shaft |
| 6 | Subsequent process organ |
| 7 | Gas space |
| 8 | |
| 9 | |
| A | General material composition of |
| | the transfer mixture |
| B | Preferred material composition of |
| | the transfer mixture |
| K | Crystallization |
| L | Solution |
| D | Thin-film evaporator |

1. Thin film evaporator (D) for producing a transfer mixture according to a direct dissolution method, comprising a feed (1), a housing (4) and an outlet (2), wherein the feed (1) introduces a starting material, made of cellulose, water and a functional fluid, into the housing (4), wherein an evaporator shaft (5) situated in the housing (4) rotatingly sweeps the starting material over the heated interior of the housing (4), wherein the starting material heats up and some of the water evaporates so as to form the transfer mixture which flows to the outlet (2) with a supply stream
wherein
the through-flow capacity of the outlet (2) is greater than the supply stream.

2. Thin film evaporator (D) according to claim 1, wherein the outlet (2) opens into a subsequent processing organ (6).

3. Thin film evaporator (D) according to claim 1, wherein the outlet opens into a subsequent transfer organ, wherein the through-flow capacity of the transfer organ is greater than the supply stream.

4. Thin film evaporator (D) according to claim 3, wherein the transfer organ is situated between the thin film evaporator (D) and the subsequent processing organ (6).

5. Thin film evaporator (D) according to claim 2, wherein the subsequent processing organ (6) is a processing organ, which further processes the transfer mixture to a molding solution.

6. Thin film evaporator (D) according to claim 2, wherein the subsequent processing organ (6) and the housing (4) form a common gas space (7).

7. Thin film evaporator (D) according to claim 2, wherein the subsequent processing organ (6) and the housing (4) and the transfer organ form a further common gas space.

8. Thin film evaporator (D) according to claim 1, wherein the functional liquid is N-Methylmorpholine-N-Oxide (NMMO) or an ionic liquid.

9. A method of producing a transfer mixture by a direct dissolution method comprising a feed (1), a housing (4) and an outlet (2), wherein the feed (1) introduces a starting material of cellulose, water and a functional liquid into the housing (4), wherein an evaporator shaft (5) situated in the housing (4) rotationally sweeps the starting material across the interior of the housing (4),
wherein the starting material heats up and some of the water evaporates to form the transfer mixture, wherein the transfer mixture flows to the outlet (2) with a supply stream, and
wherein
the through-flow capacity of the outlet (2) is greater than the supply stream.

10. Method according to claim 9,
wherein the transfer mixture passes a subsequent transfer organ, wherein the through-flow capacity of the transfer organ is greater than the supply stream.

11. Method according to claim 9,
wherein the transfer mixture is passed to a subsequent processing organ (6).

12. Method according to claim 11,
wherein the transfer mixture first passes through the transfer organ and then enters the subsequent processing organ (6).

13. Method according to claim 11, wherein the subsequent processing organ (6) further processes the transfer mixture to a molding solution.

14. Method according to claim 9, wherein N-Methylmorpholine-N-Oxide (NMMO) or an ionic liquid is added to the starting material as the functional liquid.

15. Method according to claim 14, wherein, when NMMO is used as functional liquid, the transfer mixture at the general composition of
maximum xH2O=−0.235 xCell+0.235
minimum xH2O=−0.59 xCell+0.2047
is fed as a supply stream into the outlet (2).

16. The method according to claim 14, wherein, when NMMO is used as the functional fluid, the transfer mixture at a preferred composition of
maximum xH2O=0.2864x2Cell−0.6786xCell+0.2288
minimum xH2O=0.2864x2Cell−0.6786xCell+0.2188
is fed as supply stream into the outlet (2).
